(19) United States
(12) Patent Application Publication
(10) Pub. No.: US 2025/0367056 A1
(43) Pub. Date: Dec. 4, 2025

(54) Self Standing Rollator

(71) Applicant: Craig Weaver, Crossville, TN (US)

(72) Inventor: Craig Weaver, Crossville, TN (US)

(21) Appl. No.: 18/676,966

(22) Filed: May 29, 2024

(51) Int. Cl. A61H 3/04

(52) U.S. Cl. CPC A61H 3/04; A61H 2201/0161; A61H 2201/1633; A61H 2201/1635

(57) ABSTRACT

A self-standing rollator is provided for assisting a user in walking and in moving from a seated position to a standing position. A frame is carried by a plurality of rollers. A support brace is positioned along the frame to contact a leg portion of the user to brace the frame against movement in relation to the user. At least one handle positioned along the frame to allow a user to grasp the handle when the support brace is contacting the leg portion of the user. At least one floor support member extends from a lower portion of the frame beneath the user when the support brace is contacting the leg portion of the user. Thus, when the support brace is contacting the leg portion of the user, the floor support member braces the frame against rotation as the user moves from a seated position to a standing position.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF INVENTION

The present general inventive concept pertains to rollators, and more particularly to a rollator which provides a stable and mobile support to assist a user both in walking and in moving from a seated position to a standing position.

### BACKGROUND

Rollators are commonly used by the elderly and by others with limited physical mobility to assist in standing or walking. Conventional rollators comprise a frame connected to a plurality of wheels, typically two or four wheels, and an operator gripping surface, typically a pair of handles. The handles are typically positioned near an upper portion of the frame at a height that allows a standing user to grip the handles for support while the user walks forward. The user must move the rollator forward, often by rolling the rollator forward or lifting and placing the rollator ahead of the user, whereupon the rollator provides a rigid but mobile structure upon which the user may lean for support while standing or walking. Often, rollators may include a bench or other seat surface upon which a user may support themselves for convenient resting in between movements. Conventionally, a rollator may be folded between an operating configuration and a more compact storage configuration.

Many conventional rollator designs are limited in their ability to provide stable support against forces acting in directions other than downward against the handles. For example, when a conventional rollator is placed in front of a user who is seated in a chair, on a bed, etc., and the user attempts to bear against the rollator for assistance in standing from the seated position, it is common for the user to try to pull themselves both upward and forward from the chair using the rollator handles. As a result, force is placed on the rollator handles in directions both downward and horizontally toward the user in the chair. For conventional rollators, this “angled” direction of force may be sufficient to cause the rollator to move horizontally and/or to tip, resulting in sudden, diminished support for the user. This can lead to the user falling back towards the seated position in the chair. In some extreme cases, a user may achieve a partial standing position or near-standing position only to have the rollator move or tip, whereupon the user may fall forcefully, resulting in injury and/or frightening the user and others nearby.

The above-discussed limitations of conventional rollator designs are often mitigated by having the user rely on an additional person, such as a nurse or other assistant, for support while rising to a standing position from a seated position. Thereafter the user may proceed in walking while being assisted by the rollator only. Such measures are often inconvenient in that an elderly or infirm user must rely on others to stand up, thus significantly impacting the user's freedom and independence. In other instances, a user of a rollator may limit themselves to sitting in only certain types of furniture, for example chairs with high seats or furniture with built-in handrests or other standing assistance, in order to avoid a scenario in which the user must rely on assistance from others for support in order to stand from a seated position. Such limitations may be highly inconvenient or embarassing for the user, particularly when the user is away from home and cannot control which types of furniture are available in the immediate environment for the user to sit.

In light of the above, there exists a need for an improved rollator that provides a sturdy and stable structure to assist the user in reaching a standing position from a seated position, and which also provides a movable support to assist the user in walking or standing without interfering with such movements. There is further need for an improved rollator which allows for transportability of such features along with the rollator and which allows the support features to assist the user in standing to be used with a wide variety of furniture styles, so that the support features to assist the user in walking or standing may be engaged by the user regardless of whether or not the user is in a familiar or controlled environment.

### BRIEF SUMMARY OF THE INVENTION

According to various example embodiments of the present general inventive concept, a self-standing rollator is provided that includes a frame carried by a plurality of rollers, a support brace positioned along the frame to contact a leg portion of the user to brace the frame against movement in relation to the user, at least one handle positioned along the frame to allow a user to grasp the handle when the support brace is contacting the leg portion of the user, and at least one floor support member extending from a lower portion of the frame beneath the user when the support brace is contacting the leg portion of the user. Thus, when the support brace is contacting the leg portion of the user, the floor support member braces the frame against rotation as the user moves from a seated position to a standing position. Various example embodiments of the present general inventive concept may also include a seat carried by the frame.

The foregoing and/or other aspects and advantages of the present general inventive concept may be achieved by the frame further comprising first and second substantially rigid side frames configured for expansion and contraction between a storage configuration and an operating configuration. Additional aspects and advantages of the present general inventive concept may be achieved by the self-standing rollator further comprising a seat carried by the frame, the seat comprising a flexible web extending between the first and second side frames.

Various example embodiments of the present general inventive concept may be achieved by providing a self-standing rollator wherein the support brace comprises a flexible web extending between the first and second side frames. In various embodiments, the at least one floor support member may comprise a first floor support member extending from a lower portion of the first side frame and a second floor support member extending from a lower portion of the second side frame. In various embodiments, each of the first and second floor support members may be carried by one of the plurality of rollers. In various embodiments, the first and second floor support members may define a space therebetween for the user to stand when the support brace is contacting the leg portion of the user. In various embodiments, the first and second support members may each extend horizontally in parallel-planar spaced apart relationship with a floor surface. In various embodiments, the first and second floor support members may each extend beneath the user when the support brace is contacting the leg portion of the user and the user is in the seated position.

Various example embodiments of the present general inventive concept may be achieved by providing a self-standing rollator wherein the at least one handle comprises a first armrest extending along an upper portion of the first side frame and a second armrest extending along an upper portion of the second side frame. In various embodiments, the at least one handle may further comprise a first upright handle extending proximate a forward end of the first armrest. In various embodiments, the at least one handle may further comprise a second upright handle extending proximate a forward end of the second armrest. In various embodiments, each of the upright handles may be slidably extendable. In various embodiments, each of the upright handles may extend in an outwardly canted vertical configuration.

Various example embodiments of the present general inventive concept may be achieved by providing a self-standing rollator wherein the plurality of rollers comprises a pair of linear directional wheels. In various embodiments, the plurality of rollers may comprise a pair of swivel casters. In various embodiments, each of the pair of swivel casters may carry a corresponding one of the first and second floor support members. In various embodiments, the pair of linear directional wheels may cooperate to carry the frame. In various embodiments, each of the pair of linear directional wheels may be secured to a forward end of a corresponding one of the first and second side frames.

Additional aspects and advantages of the present general inventive concept will be set forth in part in the description which follows, and, in part, will be obvious from the description, or may be learned by practice of the present general inventive concept. Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 illustrates a perspective view of a self-standing rollator according to one example embodiment of the present general inventive concept;

FIG. 2 illustrates a front view of the self-standing rollator of FIG. 1;

FIG. 3 illustrates a rear view of the self-standing rollator of FIG. 1, showing the rollator in an operating configuration;

FIG. 4 illustrates a rear view of the self-standing rollator of FIG. 1, showing the rollator in a folded configuration;

FIG. 5 illustrates a perspective view of the self-standing rollator of FIG. 1, showing a user preparing to use the self-standing rollator to assist in standing from a seated position;

FIG. 6 illustrates a perspective view of the self-standing rollator of FIG. 1, showing a user using the self-standing rollator to assist in standing from a seated position; and

FIG. 7 illustrates a perspective view of the self-standing rollator of FIG. 1, showing a user in a standing position preparing to use the self-standing rollator to assist in walking.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

According to various example embodiments of the present general inventive concept, a self-standing rollator, or “rollator,” is provided that includes a main body support frame having floor support members extending along a floor surface rearwardly of the main body to surround a region adjacent the rollator where a user would typically stand to operate the rollator. The rollator allows a user seated in a chair or other article of furniture to bring the rollator to a position in front of the user with the floor support members extending beneath the user and the article of furniture. Thus, the rollator may provide stable support structure to assist the user in moving from a seated position to a standing position while also resisting rotation of the rollator about a horizontal axis perpendicular to the rearward direction of the rollator. In various embodiments, at least one leg brace member is provided along a rear portion of the main body, and a plurality of arm brace members are provided along upper portions of the main body. Thus, the rollator may be braced against both a user's arms and legs to provide the user with a mechanical advantage to assist in standing from a seated position.

According to various example embodiments, the floor support members are spaced apart at opposite left and right sides of the main body so as not to interfere with a user standing or walking while using the rollator. And, according to various embodiments, both the floor support members and the main body of the rollator are carried by wheels, casters, or other suitable movable supports so that the floor support members may travel along with the self-standing rollator. Thus, a user may push the rollator while at the same time bearing upon various portions of the rollator for support while walking. When the user is ready to return to a seated position, the user may position the rollator in front of an article of furniture with the rear of the rollator facing the front of the article of furniture. In this configuration, the user may again employ the self-standing rollator for support while returning from a standing position to a seated position in the article of furniture.

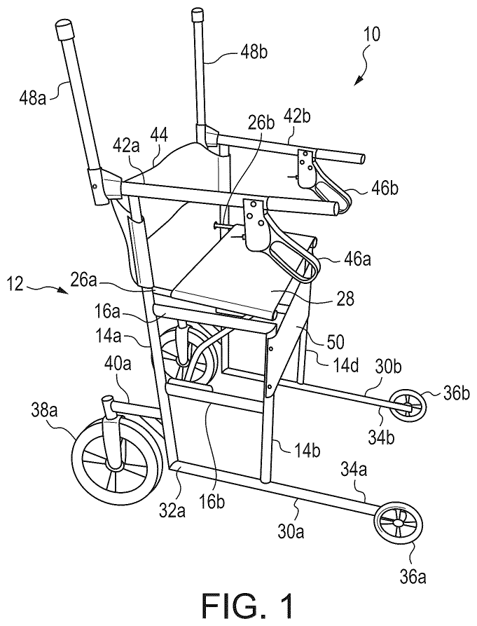

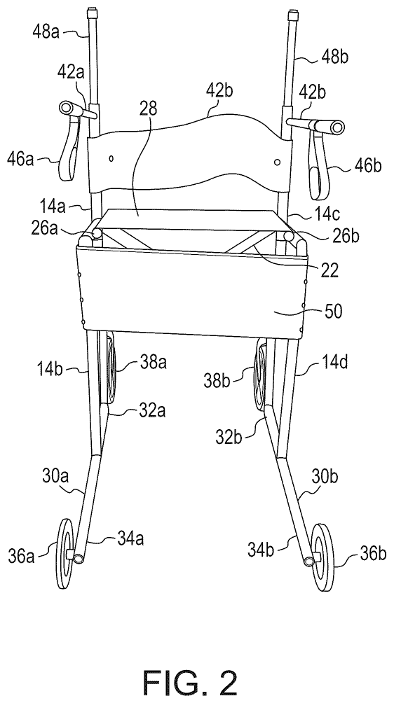

FIGS. 1-4 illustrate one example embodiment of a self-standing rollator, or “rollator,” in accordance with various aspects of the present general inventive concept. The rollator 10 of this example embodiment is shown having a main body 12 comprising four upright members 14a-14d spaced apart in a substantially rectangular configuration. The left side upright members 14a, 14b are fixed in relation to one another via horizontal cross-supports 16a, 16b; and likewise, the right-side upright members 14c, 14d are fixed in relation to one another via horizontal cross-supports 16c, 16d. Thus, the left side upright members 14a, 14b and corresponding cross-supports 16a, 16b cooperate to form a substantially rigid, vertically planar left side frame 18, and the right side upright members 14c, 14d and corresponding cross-supports 16c, 16d cooperate to form a substantially rigid, vertically planar right side frame 20.

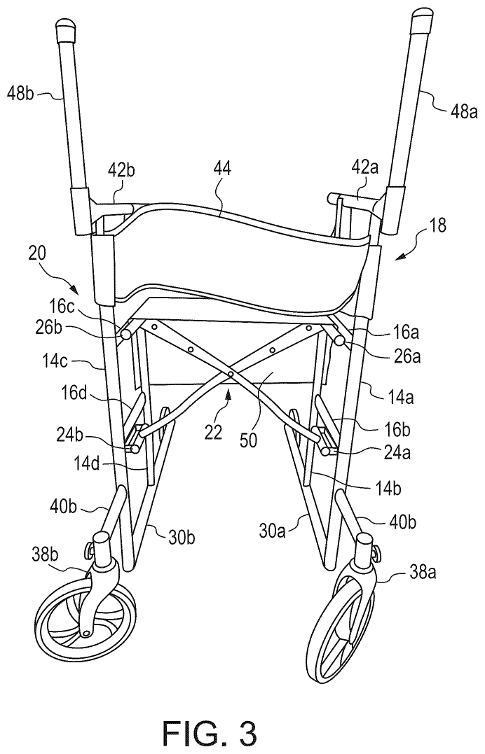

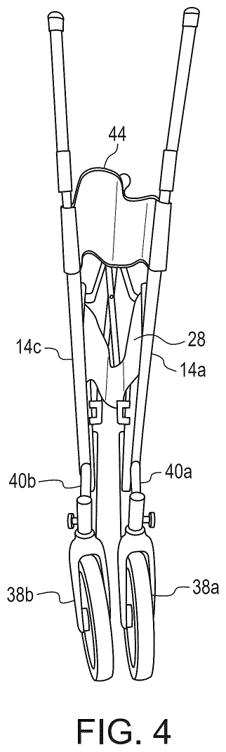

As shown in FIG. 3, a scissor linkage 22 is provided extending between the two lower horizontal cross-supports 16b, 16d. Each of the two lower distal ends of the scissor linkage 22 is rotatably connected via a hinge 24a, 24b to a corresponding one of the lower horizontal cross-supports 16b, 16d. Each hinge 24a, 24b is configured for rotation about an axis parallel to an associated cross-support 16b, 16d. Thus, the scissor linkage 22 allows the rigid left and right side frames 18, 20 to be expanded from and contracted toward one another between an expanded “operating” configuration (see FIG. 3) and a contracted “folded” configuration (see FIG. 4).

The scissor linkage 22 extends upward from the two lower horizontal cross-supports 16b, 16d and terminates above the two upper horizontal cross-supports 16a, 16c. In the illustrated embodiment, a seat support member 26a, 26b is provided at each of the two upper distal ends of the scissor linkage 22, with each seat support member 26a, 26b extending generally parallel to the cross-support members 16a-16d and generally perpendicular to the rotational plane of the scissor linkage 22. A flexible seating web 28 is secured at respective opposite edges thereof to the seat support members 26a, 26b and extends therebetween. Thus, when the left and right side frames 18, 20 are expanded away from one another to the operating configuration, the seating web 28 is expanded taught to limit further rotation of the scissor linkage 22 beyond the operating configuration. When the left and right side frames 18, 20 are contracted toward one another toward the folded configuration, the seating web 28 is allowed to hang loosely between the seat support members 26a, 26b. In certain embodiments, as the left and right side frames 18, 20 reach the folded configuration, the seat support members 26a, 26b contact and abut one another to limit further rotation of the scissor linkage 22 beyond the folded configuration. Thus, it will be understood that the seat support members 26a, 26b and associated seating web 28 serve to limit rotation of the scissor linkage 22 and movement of the left and right side frames 18, 20 between the operating and folded configurations.

In various alternate embodiments, an additional locking mechanism (not shown) is provided to allow the scissor linkage 22 to be expanded and locked in the operating configuration, such that in the operating configuration, the left and right side frames 18, 20 may cooperate with the locked scissor linkage 22 to form a substantially rigid support frame of suitable width to extend slightly wider than the stance of a user operating the rollator. However, it will be recognized that inclusion of such additional locking mechanism is not strictly necessary in order to accomplish a rollator in accordance with various aspects of the present general inventive concept. It will further be recognized that, in the folded configuration, the width between the left and right side frames 18, 20 may be reduced, and optimally minimized, to permit the rollator to be more easily transported and/or stored.

With reference to FIG. 1, in various embodiments, a pair of floor support members 30a, 30b are provided, with each floor support member extending horizontally rearwardly from a corresponding lower rear corner of a corresponding one of the frames 18, 20. For example, in the illustrated embodiment, a first floor support member 30a has a forward end 32a thereof fixed to a lower end of the left side front upright member 14a, and a rearward end 34a that extends rearward behind the left frame 18. A central portion of the first floor support member 30a is fixed to a lower end of the left side rear upright member 14b. Thus, a forward portion of the first floor support member 30a forms a lower edge of the left frame 18, while a rearward portion of the first floor support member 30a extends rearward of the left frame 18. Likewise, a second floor support member 30b has a forward end 32b thereof fixed to a lower end of the right side front upright member 14c, and a rearward end 34b that extends rearward behind the right frame 20. A central portion of the second floor support member 30b is fixed to a lower end of the left side rear upright member 14d. Thus, a forward portion of the second floor support member 30a forms a lower edge of the right frame 20, while a rearward portion of the second floor support member 30b extends rearward of the right frame 20.

In various embodiments, a plurality of wheels, casters, or other suitable movable supports are provided along lower portions of the left and right side frames 18, 20 and first and second floor support members 30a, 30b to allow the body 12 of the rollator to be rolled, slid, or otherwise translated across a support surface, such as the floor or ground. For example, in the illustrated embodiment, a pair of linear directional wheels 36a, 36b are provided, with each linear directional wheel 36a, 36b being disposed at a corresponding one of the rearward ends 34a, 34b of the first and second floor support members 30a, 30b. Each of the linear directional wheels 36a, 36b is oriented to allow the corresponding rearward end 34a, 34b of the first and second floor support members 30a, 30b to roll in forward and backward directions of the body 12, in other words, along the elongate linear direction of the first and second floor support members 30a, 30b, parallel to the planes defined by the left and right side frames 18, 20. Additionally, a pair of swivel casters 38a, 38b are provided proximate a lower forward corner of the left and right side frames 18, 20. More specifically, a first swivel caster 38a is secured to a first mounting member 40a that extends forwardly from the left side front upright member 14a, slightly above the intersection of the first floor support member 30a and the lower end of the left side front upright member 14a. Likewise, a second swivel caster 38b is secured to a second mounting member 40b that extends forwardly from the right side front upright member 14b, slightly above the intersection of the second floor support member 30b and the lower end of the right side front upright member 14b. The first and second linear directional wheels 36a, 36b and swivel casters 38a, 38b cooperate to support and maintain the body 12 of the rollator a short distance above a floor or ground surface, such that the rollator body 12 may be rolled in forward and rearward directions, with the forward swivel casters 38a, 38b further allowing left and right turning ability of the rollator body 12.

FIGS. 3 and 4 illustrate the rollator 10 in the above-discussed expanded “operating” configuration and a contracted “folded” configuration, respectively. With reference to these figures, in various embodiments, when the left and right side frames 18, 20 are expanded away from one another from the folded configuration (see FIG. 4) to the operating configuration (see FIG. 3), the seating web 28 is stretched taught between the above-discussed seat support members 26a, 26b. In this configuration, the seating web 28 provides a seating surface upon which a user may sit, for example, to rest or remain stationary. In the illustrated embodiment, a pair of armrest members 42a, 42b extend from upper ends of the front upright members 14a, 14b horizontally rearward, such that the armrest members 42a, 42b are positioned slightly above and on opposite sides of the seating web 28. In the illustrated embodiment, a flexible backrest web 44 is provided extending between upper portions of the front upright members 14a, 14b between the armrest members 42a, 42b and the upper horizontal cross-supports 16a, 16c. Thus, when the rollator 10 is in the operating configuration, a user may sit on the seating web 28 facing to the rear of the rollator 10 with the user's back resting against the backrest web 44. In this configuration, the armrest members 42a, 42b are positioned on either side of the user, such that they user may rest their arms comfortably upon the armrest members 42a, 42b.

In the illustrated embodiment, a pair of brake levers 46a, 46b are provided, each brake lever 46a, 46b being disposed proximate a rearward end of a corresponding one of the armrest members 42a, 42b. The brake levers 46a, 46b are operatively connected via suitable linkages to brake cables (not shown), which are in turn connected to wheel brake mechanisms configured to arrest movement of at least one, and preferably more than one, of the directional wheels 36a, 36b or swivel casters 38a, 38b. Thus, a user seated on the seating web 28 of the rollator 10 may squeeze one or both of the brake levers 46a, 46b to arrest rolling movement of the rollator 10 while the user stands from the seated position. It will be recognized that, in this scenario, a user may optionally lean or otherwise bear weight upon the armrest members 42a, 42b to assist the user in standing.

With reference now to FIGS. 1-4, in various embodiments, a pair of upright handles are provided at forward ends of the armrest members 42a, 42b near the upper ends of the front upright members 14a, 14b. In the illustrated embodiment, each of the first and second armrest members 42a, 42b is fixed to an upper end of a respective one of the front upright members 14a, 14b near a forward end of the respective first or second armrest member 42a, 42b. A pair of upright handles 48a, 48b are provided, each upright handle 48a, 48b being slidably secured to a forward end of a respective one of the first and second armrest members 42a, 42b. Thus, each upright handle 48a, 48b can be slidably extended upward to project substantially upwardly from a forward end of a respective armrest member 42a, 42b or slidably retracted downward to extend substantially downwardly from the forward end of a respective armrest member 42a, 42b. In the illustrated embodiment, each of the two upright handles 48a, 48b is canted slightly outwardly from a vertical plane along the respective armrest member 42a, 42b. However, it will be recognized that such outward cant of the upright handles 48a, 48b is not strictly necessary to accomplish a rollator 10 in accordance with certain features of the present general inventive concept.

In accordance with several features of the present general inventive concept, in various embodiments, a support brace 50 is provided extending horizontally between rearward upright members 14b, 14d of the rollator main body 12 at a height that allows for contact between the support brace 50 and a user's knees or shins. For example, in the illustrated embodiment, a support brace 50 is provided in the form of a flexible web extending between respective upper portions of the rearward upright members 14b, 14d, between the upper cross-supports 16a, 16c and the lower cross-supports 16b, 16d. In the folded configuration, the flexible support brace 50 hangs loosely between the rearward upright members 14b, 14d. However, in the operating configuration, the support brace 50 is stretched taught between the rearward upright members 14b, 14d, such that the support brace 50 provides a surface against which the user's knees or shins may bear for support.

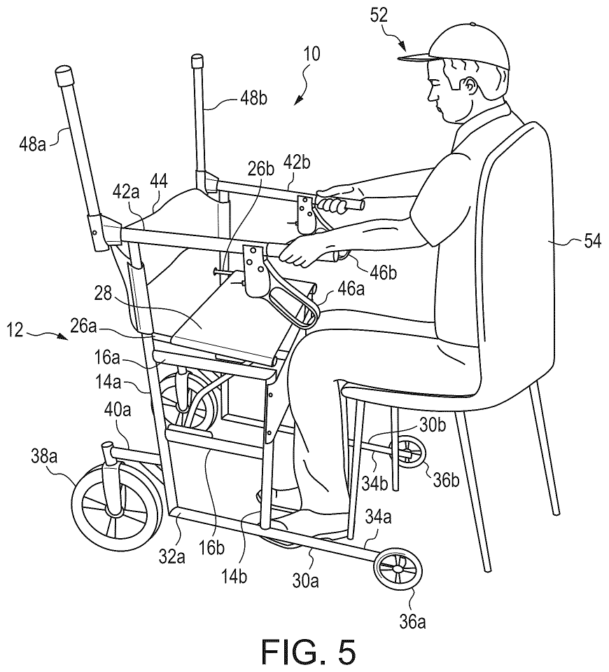

FIGS. 5-7 illustrate one use of the rollator 10 in accordance with several aspects of the present general inventive concept. As shown in FIGS. 5-7, in one application, a user 52 who is seated in a chair or other article of furniture 54 may position the rollator 10 in front of the user's knees or shins, with the rear of the rollator 10 facing the user and the support brace 50 contacting the user's knees or shins. In this position, the floor support members 30a, 30b extend beneath the user's knees and rearward along the floor beneath the user and the article of furniture 54. Ideally, the floor support members 30a, 30b extend beneath the center of gravity of the user when the user is seated in the article of furniture 54. However, it will be recognized that, while optimal, extension of the floor support members 30a, 30b fully beneath the user's center of gravity is not mandatory to accomplish various features of the present general inventive concept. Thus, for example, in several embodiments, the floor support members 30a, 30b extend only partially between the lower corners of the side frames 18, 20 and the center of gravity of the user when the user is seated in the article of furniture 54.

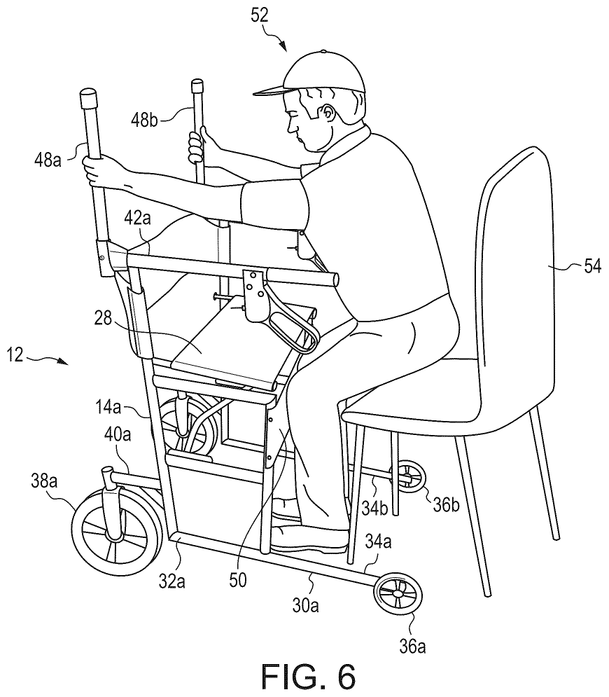

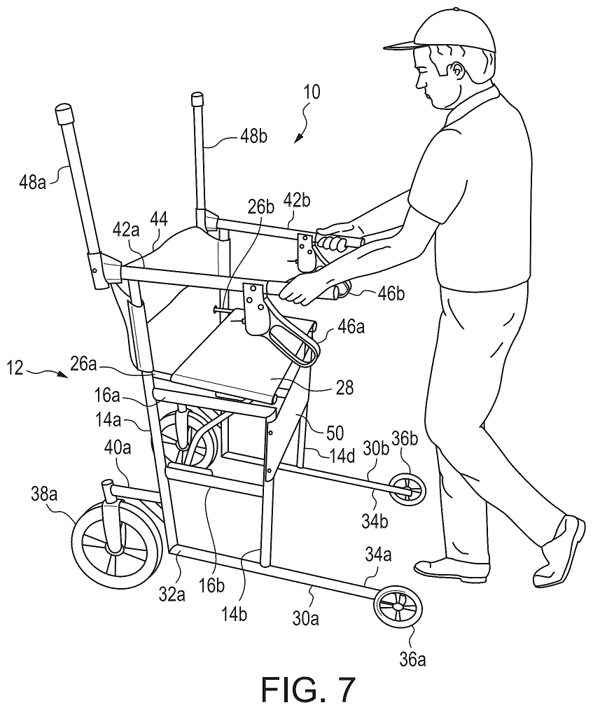

As shown in FIGS. 5-6, the rollator 10 may provide support and assistance to the user in moving to a standing position either by the user gripping the rearward ends of the armrest members 42a, 42b (see FIG. 5) or by the user placing their arms along the armrest members 42a, 42b and gripping the upright handles 48a, 48b (see FIG. 6). In either of these two positions, the user may lean or otherwise bear upon the armrest members 42a, 42b and the support brace 50, whereupon the support brace 50 limits the rollator from rolling rearward in relation to the user's knees or shins, and the support brace 50 and floor support members 30a, 30b cooperate to brace the rollator 10 against vertical rotation toward the user. Thus, the rollator 10 provides a relatively stable and secure support structure to assist the user in moving from a seated position in the article of furniture 54 (FIG. 5) to a standing position rearward of the rollator 10 (FIG. 7), notwithstanding the fact that the rollator 10 is supported from the floor by wheels 38a, 38b and casters 38a, 38b and is thus generally free to roll.

Once a standing position is achieved by the user (see FIG. 7), the user may operate the rollator 10 in a conventional manner. That is, the user may grip the rearward ends of the armrest members 42a, 42b and lean upon the rollator 10 for support while walking. Throughout this, the user may optionally actuate the brake levers 46a, 46b to slow or arrest rolling of the rollator 10, for example to prevent the rollator 10 from moving out beneath a bearing weight of the user. Alternatively, the user may stand in front of the rollator 10 facing rearward and grip the upright handles 48a, 48b for support while walking. Upon reaching a destination at which the user wishes to sit again, such as for example another article of furniture 54 or the same article of furniture 54, the user may stand in front of the furniture 54 with the user's knees or shins against the support brace 50 and the floor support members 30a, 30b extending beneath the article of furniture 54. In this position, the user may once again return to a seated position in the article of furniture 54, using the combination of the support brace 50 and armrest members 42a, 42b, with or without gripping the upright handles 48a, 48b, for support and bracing while returning to the seated position.

From the foregoing description, it will be recognized that a self-standing rollator is provided that allows for improved support for a user against both horizontal translational rolling and “tipping” of the rollator while relying on the rollator during standing and sitting. Furthermore, it will be recognized that a self-standing rollator is provided that allows for the rollator to be quickly and conveniently collapsed to the folded configuration for storage and transport, and which also allows for the rollator to be quickly and conveniently expanded to the operating configuration for deployment.

It will be recognized that numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A device for assisting a user in walking and in moving from a seated position to a standing position, the device comprising:
a frame carried by a plurality of rollers;
a support brace positioned along the frame to contact a leg portion of the user to brace the frame against movement in relation to the user;
at least one handle positioned along the frame to allow a user to grasp the handle when the support brace is contacting the leg portion of the user; and
at least one floor support member extending from a lower portion of the frame beneath the user when the support brace is contacting the leg portion of the user;
wherein when the support brace is contacting the leg portion of the user, the floor support member braces the frame against rotation as the user moves from a seated position to a standing position.

2. The device of claim 1 further comprising a seat carried by the frame.

3. The device of claim 1, the frame further comprising first and second substantially rigid side frames configured for expansion and contraction between a storage configuration and an operating configuration.

4. The device of claim 3, further comprising a seat carried by the frame, the seat comprising a flexible web extending between the first and second side frames.

5. The device of claim 3, wherein the support brace comprises a flexible web extending between the first and second side frames.

6. The device of claim 3, wherein the at least one floor support member comprises a first floor support member extending from a lower portion of the first side frame and a second floor support member extending from a lower portion of the second side frame.

7. The device of claim 6, each of the first and second floor support members being carried by one of the plurality of rollers.

8. The device of claim 7, the first and second floor support members defining a space therebetween for the user to stand when the support brace is contacting the leg portion of the user.

9. The device of claim 8, the first and second support members each extending horizontally in parallel-planar spaced apart relationship with a floor surface.

10. The device of claim 9, the first and second floor support members each extending beneath the user when the support brace is contacting the leg portion of the user and the user is in the seated position.

11. The device of claim 1, wherein the at least one handle comprises a first armrest extending along an upper portion of the first side frame and a second armrest extending along an upper portion of the second side frame.

12. The device of claim 11, wherein the at least one handle further comprises a first upright handle extending proximate a forward end of the first armrest.

13. The device of claim 12, wherein the at least one handle further comprises a second upright handle extending proximate a forward end of the second armrest.

14. The device of claim 13, wherein each of the upright handles is slidably extendable.

15. The device of claim 14, each of the upright handles extending in an outwardly canted vertical configuration.

16. The device of claim 7, wherein the plurality of rollers comprises a pair of linear directional wheels.

17. The device of claim 16, wherein the plurality of rollers comprises a pair of swivel casters.

18. The device of claim 17, wherein each of the pair of swivel casters carries a corresponding one of the first and second floor support members.

19. The device of claim 18, wherein the pair of linear directional wheels cooperate to carry the frame.

20. The device of claim 19, wherein each of the pair of linear directional wheels is secured to a forward end of a corresponding one of the first and second side frames.
